(19) United States
(12) Patent Application Publication
(10) Pub. No.: US 2004/0231968 A1
(43) Pub. Date: Nov. 25, 2004

(54) Tact switch

(76) Inventors: Wei Yu, Kunsan (CN); Yong Hui Hu, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/853,435

(22) Filed: May 24, 2004

(30) Foreign Application Priority Data
May 23, 2003 (TW) 92209567

(51) Int. Cl. H01H 5/00

(52) U.S. Cl. 200/402

(57) ABSTRACT

A tact switch includes: an insulative base (7), a plurality of contacts (741) partially retained in the insulative base (7) and partially exposed to exterior, a cover (1) engaging to the insulative base (7), a conductor plate (6) mounted on the insulative base (7) and comprising resilient contacts (60) for movably contacting the contacts (741), a metal dome (5) positioned on the conductor plate (6) and having a pressing portion (51) for movably and elastically contacting the resilient contacts (60), a supporting plate (3) being positioned over the metal dome (5) and being fixed in the insulative base (7), the supporting plate (3) having a planar main body defining a hole (30) and a tab (32), and a flexible arm (33) extending from the tab (32) of the main body toward the pressing portion (51) of the metal dome (5), and an actuator (2) being movably received between the insulative base (7) and the cover (1) and having a ramp (241) for downwardly actuating the flexible arm (33) to contact the metal dome (5).

### BACKGROUND OF THE INVENTION

1. Field of the Invention

The present invention relates to a switch, and particularly to a tact switch for an electronic device.

2. Description of Prior Art

Tact switches which have quick response to a manual depression have been used in many appliances such as in telephone sets, microwaves, remote controls, digital camera, TV sets, and etc. A conventional tact switch generally includes a cover with a fixable arm, an actuator with a ramp, a supporting plate, a water proof, a metal dome, a conductor plate defined resilient contacts, an insulative base and a plurality contacts embedded therein, as disclosed in the U.S. Pat. No. 6,018,132. The actuator has a T-shaped body, on which the ramp is formed. In operation, pressing the actuator horizontally towards the cover, the ramp of the actuator drives the flexible arm 33 move downward, meanwhile, the flexible arm 33 forces the metal dome, which in turn depresses the resilient contacts of the conductor plate to electrically connecting the contacts embedded in the insulative base. When the depression is released, the metal dome recovers to the original shape, the water-proof tape moves upwardly, and the actuator moves horizontal backward to its original position. In assembly, the actuator is mounted the insulative base and then the cover is fixed to the insulative base with the flexible arm 33 being partially pressed under and engaging with the push portion of the actuator. However, one of the problems of the conventional tact switch described above centers around injury of the flexible arm 33 and the life of it. Simultaneity, The push portion of the actuator press the flexible arm 33 and partially insert between the flexible arm 33 and the cover. During being pressed under the push portion, due to large interference force with the push portion, the flexible arm 33 tend to be injured or be cause damaged, resulting in an unreliable engagement with the push portion. In the other hand, the neck of the flexible arm 33 is a little narrow, and stress focusing on the neck easily causes tiredness, thereby shortening the life of the switch.

It is requisite to provide an improved structure of a tact switch for solving the above problem.

### BRIEF SUMMARY OF THE INVENTION

A primary object of the present invention is to provide an improved switch, which can prevent the injury of the flexible arm 33, distract from the focus stress on the neck of the arm, improve the ability of the product to endure the tiredness, and prolong the life of the switch.

In accordance with one aspect of the present invention, a switch comprises an insulative base, contacts embedded in the housing, a conductor plate defined movable contact, a metal dome, a water-proof tape, a supporting plate, a actuator and a cover. And the insulative base defined with contacts, conductor plate defined with spring arms. The main body of the supporting plate is a plan plate, defined a cutout in the central, and has tabs extend from the lever edge. A flexible arm 33 defined on the central of the tab extends downward to the cutout. The actuator has a push portion defined with a ramp. The pressing plate has a pressing portion. After assembled, during operation, the actuator is pressed horizontally to the cover, and the push portion of the actuator will drive the flexible arm 33 move downward, meanwhile, the flexible arm 33 will force the metal dome, which in turn depresses the conductor plate and causes the spring arms and their bent ends to electrically connecting the four contacts.

To compare with the conventional technology, the merit of this invention is the flexible arm 33 is defined on the supporting plate. In assembling, it can effectively prevent the injury of the flexible arm 33, and when the flexible arm 33 working, the tab that the neck connected can also endure the stress, so it can distract from the focus stress on the neck of the arm and prolong the life of the product.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded view of a switch in accordance with the present invention;

FIG. 2 is a perspective view of an actuator of the switch of FIG. 1;

FIG. 3 is a perspective view of the cover of the switch of FIG. 1;

FIG. 4 is an assembled view of the switch of FIG. 1;

FIG. 5 is a cross-sectional view taken from line 5-5 of FIG. 4 showing the metal dome not depressed; and

FIG. 6 is a cross-sectional view taken from line 5-5 of FIG. 4 showing the metal dome being depressed.

### DETAILED DESCRIPTION OF THE INVENTION

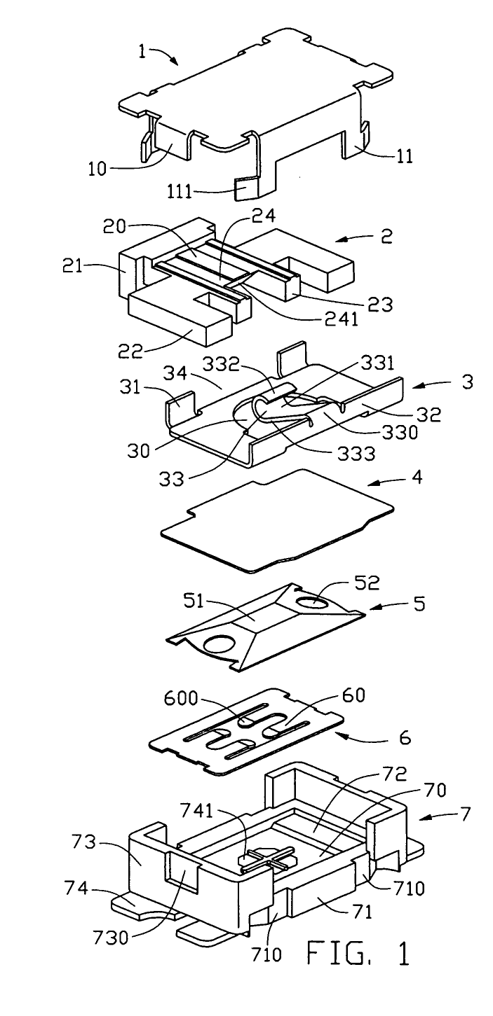

Referring to FIGS. 1, 2 and 3, a tact switch comprises a cover 1, an actuator 2 with a ramp 241, a supporting plate 3 having a flexible arm 33, a water-proof tape 4, a metal dome 5, a conductor plate 6 defined with resilient contacts 60, an insulative base 7 and a plurality contacts 741 embedded in housing 70.

Also referring to FIG. 3, the cover 1 has a pair of tabs 10 extending downward from opposite side edges, and has a pair of tangs 11 extending downward from the other two side edges. Each tang 11 has a bent end 111 laterally extending from a lower end thereof.

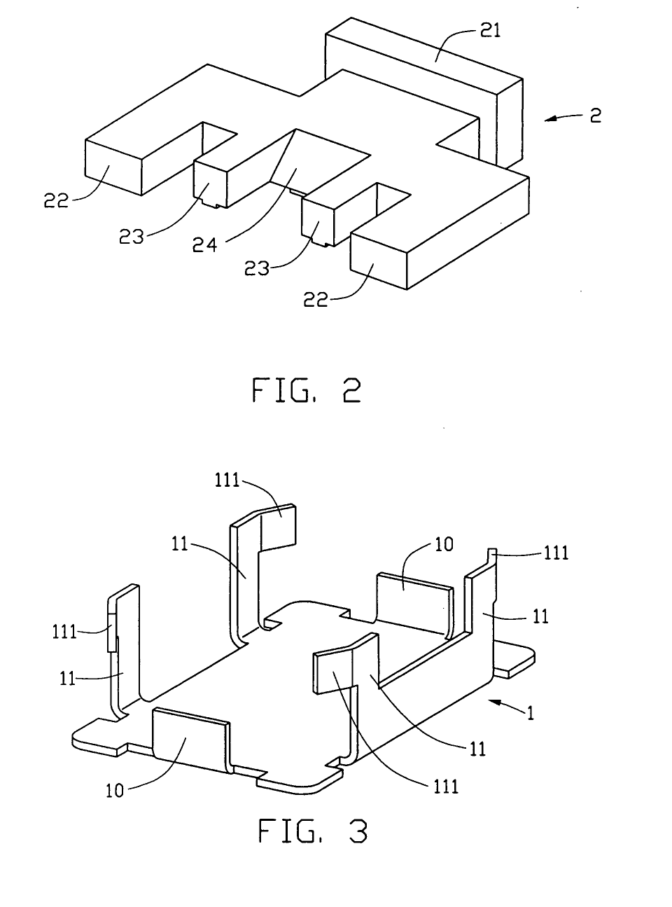

Also referring to FIG. 2, the actuator 2 has a substantially T-shaped configuration. A push hand 21 is defined on the end of the actuator 2. A pair of out fingers 22 extends horizontally from the two sides of the head of the actuator 2. And two inner fingers 23 are formed separately between the out fingers 22. Rails 231 are formed on the top surface of the inner finger 23. A push portion 24 is formed between the inner fingers 23 which have a ramp 241. Between the rails 231, a slide 20 is formed on the surface of the actuator.

Also referring to FIG. 1, the supporting plate 3 is made of metal plate. A pair of first tabs 31 extends upward from opposite sides of a rear edge of the supporting plate 3. A cutout 34 is defined between the first tabs 31. The supporting plate 3 comprises a second tab 32 extending upward from a front edge thereof. The supporting plate 3 defines a hole 30 adjacent to the second tab 32. A flexible arm 33 rearward extends from a middle portion of an upper edge of the second tab 32 and is cantilevered over the hole 30. The flexible arm 33 is joined to the second tab 32 by a neck 330. The flexible arm 33 comprises a free end being bent to form a curved portion 331. The curved portion has a rearward projecting convex surface. An upper contacting portion 332 and a lower contacting portion 333 are respectively formed on upper and lower surfaces of the curved shape 331. Both the upper contacting portion 332 and a lower contacting portion 333 are very smooth. The neck 330 has an upper convex surface and provides the flexible arm 33 with flexibility.

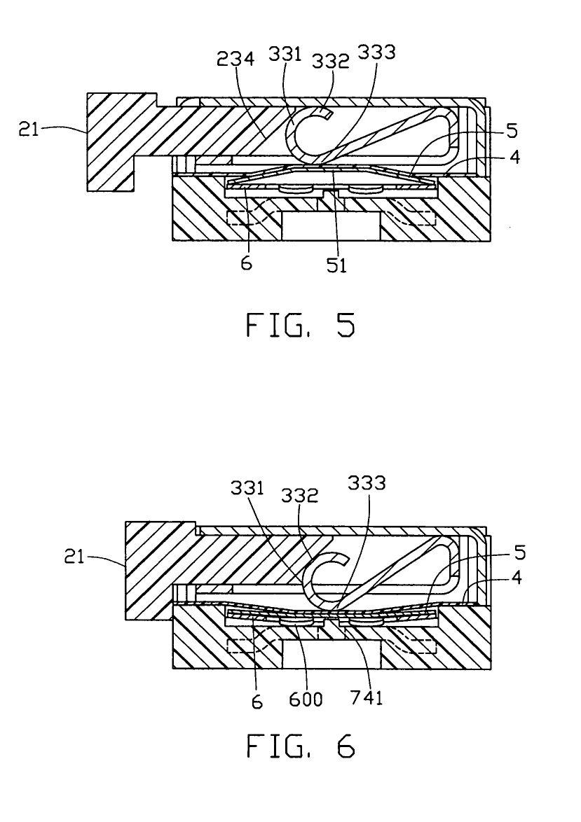

Also referring to FIGS. 1 and 5, the metal dome 5 is shaped like the pyramid and has an upper central rectangular pressing portion 51, and a pair of holes 52 at the two sides of the pressing portion 51. The water-proof tape 4 is made of insulative material. The water-proof tape 4 is adhered to the pressing portion 51 of the metal dome 5. The conductor plate 6 has four spring arms 60 defined in the middle area thereof. Each spring arm 60 has a downwardly bent end 600.

Also referring to FIGS. 1, 5 and 6, The insulative base 7 comprises a housing 70 and four contacts 74 embedded in the housing 70. Four contacting portions 741 of the contacts 74 expose to external from the upper surface of the housing 10, which is used to connect with said spring arms 60 and electrically independent from each other. A pair of steps 72 is formed on opposite sides of the upper surface of the housing 70. A periphery wall 71 encloses around the housing 70 and is higher than the steps 72. Four shallow portions 710 are defined in lower portions of front and rear sides of the periphery wall 71 for engagement with the bent ends 111 of the tangs 11 of the cover 1. Two U-shaped upper walls 73 extend upwardly from opposite sides of the periphery wall 71. Two grooves 730 are defined in outer surfaces of opposite sides of the U-shaped upper walls 73.

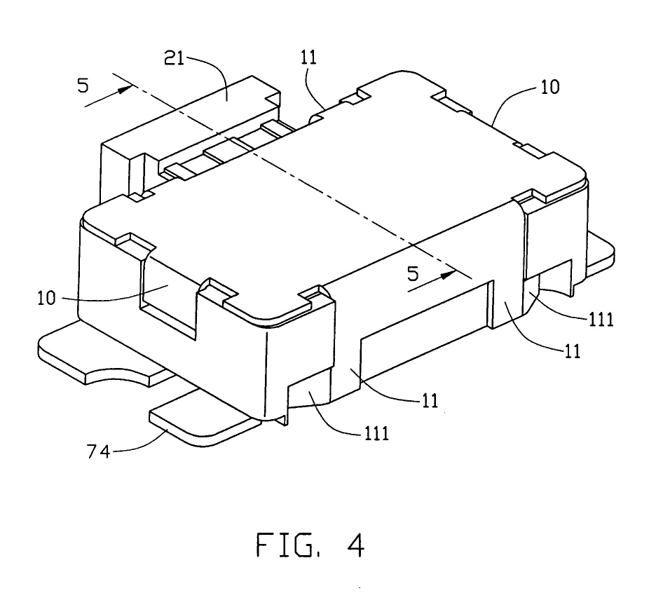

In assembly, the conductor plate 6 is positioned on the two steps 72, with edges abutting the respective inner sides of the periphery wall 71,thereby being fixed on the insulative base 7. Make sure the bent ends 600 of the spring arms 60 of the conductor plate 6 aligning with but being normally apart from the contacting portions 741 of the contacts 74 embedded in the insulative base 7. The metal dome 5 is put on the conductor plate 6 directly with edges thereof abutting against the respective inner sides of the periphery wall 71 to prevent the metal dome 5 from gliding over the conductor plate 6. The water-proof tape 4 is positioned on the pressing portion 51 of the metal dome 5. In operation, the water-proof tape 4 can move upwardly and downwardly with the movement of the pressing portion 51 of the metal dome 5. The supporting plate 3 is fixed on the upper surface of the periphery wall 71 of the base 70. The outer sides of the second tab 32 and the first tabs 31 respectively abut against inner sides of the U-shaped upper walls. The actuator 2 is positioned on the supporting plate 3. The flexible arm 33 is positioned between the two inner fingers 23 of the actuator 2. The push hand 21 of the actuator 2 extends out the supporting plate 3 from the cutout 34 defined between the first tabs 31. Finally, the cover 1 is assembled onto the base 7 by engaging the bent ends 111 of the tangs 11 with the shallow portions 710 of the periphery wall 71, and engaging the tabs 10 thereof with the grooves 730 of the U-shaped upper walls 73. Meanwhile, the rails 231 and the slide 20 of the actuator 2 contacts with the surface the horizontal actuator 2, then fixing the cover 1 with the insulative base 7, and the assembled tact switch 8 is show in the FIG. 4.

Referring to the FIGS. 5 and 6, the FIG. 6 is the status while the tact switch 8 is off. During operation, a user horizontally pushes the push hand 21 of the actuator 2, and the push hand 21 move horizontally toward the second tab 32 on the supporting plate 3. Meanwhile, the ramp 241 of the push portion 24 stresses on the upper contact portion 322 of the flexible arm 33, and drives the flexible arm 33 to pivotally move downward around the neck 33. During the movement, the lower contact portion 333 of the flexible arm 33 is driven to depress downward the pressing portion 51 of the metal dome 5 through the water-proof tape 4. And the pressing portion 51 will push the bent ends 600 of the spring arms 60 down to electrically contact with the contacting portion 741 of the contacts 74 embedded in the base 70, As a result, the tact switch 8 is pushed in a closed position as shown in FIG. 6.

In the present invention, being formed integrally with the supporting plate 3, the flexible arm 33 is fixed on the insulative base before assembling the actuator 2, thereby effectively avoiding the injury of the flexible arm 33. The neck 330 connecting the flexible arm 33 with the supporting plate 3 can also endure the stress, so the design can make the second tab 32 distract from the focus stress on the neck 330, and prolong the life of the tact switch of the present invention.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

What is claimed is:

1. A tact switch comprising:
an insulative base;
a plurality of contacts partially retained in the insulative base and partially exposed to exterior;
a cover engaging to the insulative base;
a conductor plate mounted on the insulative base and comprising resilient contacts for movably contacting the contacts;
a metal dome positioned on the conductor plate and having a pressing portion for movably and elastically contacting the resilient contacts;
a supporting plate being positioned over the metal dome and being fixed in the insulative base, the supporting plate having a planar main body defining a hole and a tab, and a flexible arm extending from the tab of the main body toward the pressing portion of the metal dome; and
an actuator being movably received between the insulative base and the cover and having a ramp for downwardly actuating the flexible arm to contact the metal dome.

2. The switch as claimed in claim 1, comprising an insulative plate positioned between the metal dome and the supporting plate.

3. The switch as claimed in claim 1, the ramp of the actuator comprises a distal end extending between the cover and the flexible arm of the supporting plate.

4. The switch as claimed in claim 1, wherein the flexible arm of the supporting plate is movable into the hole of the supporting plate.

5. The switch as claimed in claim 4, wherein the supporting plate comprises a tab, and the flexible arm has a neck connecting with the tab.

6. The switch as claimed in claim 1, wherein the cover comprises a tang extending from a side edge, and a tab extending from another side edge, the tang comprising a bent end.

7. The switch as claimed in claim 5, wherein the insulative base defines a groove engaging with the tab of the cover and a shallow portion engaging with the bent end of the tang of the cover.

8. The switch as claimed in claim 1, wherein the insulative base has a peripheral wall extending upward, the shallow portion being defined in the periphery wall.

9. The switch as claimed in claim 8, wherein a U-shaped upper wall extends upward from the periphery wall, and the groove is defined in the U-shaped upper wall.

10. A tact switch comprising:
an insulative base;
a plurality of fixed contacts partially retained in the insulative base and partially exposed to exterior;
a cover engaging to the insulative base;
a conductor plate positioned above the fixed contacts and including resilient contacts vertically aligned with the corresponding fixed contacts, respectively,
a metal dome positioned above the conductor plate and having a pressing portion for movably and elastically mechanically and electrically contacting said resilient contacts;
a supporting plate being positioned over the metal dome while under the cover and being fixed in the insulative base, the supporting plate integrally forming a flexible arm downwardly deflectable toward the metal dome thereunder; and
an actuator being received between the insulative base and the cover in a vertical direction while being moveable in a horizontal direction so as to downwardly pressing the flexible arm.

11. The switch as claimed in claim 10, wherein said supporting plate includes opposite vertical tabs commonly defining a space receiving the actuator, and said flexible arm extends from an edge of one of said tabs.

12. The switch as claimed in claim 11, wherein the edge of one of said tabs is located higher than other portions of said supporting plate

13. The switch as claimed in claim 12, wherein said supporting plate includes an opening through which the flexible arm extends when said flexible arm is downwardly pressed by said actuator.
